(19) United States
(12) Patent Application Publication
(10) Pub. No.: US 2023/0347887 A1
(43) Pub. Date: Nov. 2, 2023

(54) SYSTEMS AND METHODS FOR DRIVER-PREFERRED LANE BIASING

(71) Applicant: TOYOTA RESEARCH INSTITUTE, INC., LOS ALTOS, CA (US)

(72) Inventors: GABRIELLE M. FAVREAU, Los Altos, CA (US); Carrie G. BOBIER-TIU, Los Altos, CA (US); Sarah M. KOEHLER, Los Altos, CA (US); Matthew J. BROWN, Los Altos, CA (US); Guillermo PITA GIL, Redwood City, CA (US)

(73) Assignees: TOYOTA RESEARCH INSTITUTE, INC., Los Altos, CA (US); TOYOTA JIDOSHA KABUSHIKI KAISHA, Toyota-Shi (JP)

(21) Appl. No.: 17/732,320

(22) Filed: Apr. 28, 2022

(51) Int. Cl. B60W 30/12; B60W 40/09

(52) U.S. Cl. CPC B60W 30/12; B60W 40/09; B60W 2552/53; B60W 2552/10; B60W 2540/30; B60W 2555/20

(57) ABSTRACT

Systems and methods are provided for lane biasing, e.g., positioning a vehicle within a current lane of travel. Lane biasing can be dependent on learned driver behaviors or other factors that may impact lane biasing, e.g., weather conditions, traffic conditions, and so on (which may also be learned). Lane biasing may result in a vehicle traveling, e.g., off the center-line of a current lane of travel, and is distinguished from conventional lane keep assist systems that merely position a vehicle in the center of a current lane of travel by default.

### TECHNICAL FIELD

The present disclosure relates generally to lane keeping or lane keep assistance. More particularly, the present disclosure relates to biasing the positioning of a vehicle within a lane of roadway depending on learned driver preferences or behaviors.

### DESCRIPTION OF RELATED ART

Lane keeping or lane keep assist/assistance (LKA) can refer to a feature included in some vehicles that operates to keep a vehicle in a current lane of travel. For example, if the vehicle, in particular a vehicle's LKA system or mechanism, detects or determines that the vehicle is veering out of the current lane of travel, an alert (such as a sound, flashing light, or vibration) may be presented to the driver. This alert lets the driver know he/she is at risk of leaving the current lane of travel. In some systems, if a driver does not take action to reposition the vehicle within the current lane of travel, the LKA system may autonomously steer the vehicle back into a desired position within the current lane of travel. If the driver actually intends to change lanes, the driver may override the autonomous steering or ignore the alert, and operate the steering wheel to move/turn in the desired direction.

### BRIEF SUMMARY OF THE DISCLOSURE

In accordance with one embodiment, a method comprises: determining a current position of a vehicle in a lane of travel; determining a lane biasing preference applicable to at least one of the vehicle or the driver of the vehicle; calculating a distance offset relative to the current position of the vehicle resulting in a lane biasing position commensurate with the lane biasing preference; and autonomously or semi-autonomously controlling the vehicle to move from the current position of the vehicle in the lane of travel to the lane biasing position in accordance with the calculated distance offset.

In some embodiments, determining the lane biasing preference comprises obtaining the lane biasing preference from at least one of a vehicle profile, a passenger profile, or a driver profile.

In some embodiments, the vehicle profile comprises information reflecting at least one of physical vehicle characteristics or vehicle operating characteristics.

In some embodiments, the driver profile comprises information reflecting physical driver characteristics, and wherein the passenger profile comprises information reflecting physical passenger characteristics.

In some embodiments, determining the lane biasing preference comprises executing a machine learning model to predict the lane biasing preference.

In some embodiments, determining the lane biasing preference further comprises perceiving at least one of current driver conditions, current passenger conditions, current vehicle operating conditions, current environmental conditions, and current road conditions.

In some embodiments, determining the lane biasing preference further comprises adjusting the lane biasing preference in accordance with the at least one of the current driver conditions, current passenger conditions, current vehicle operating conditions, current environmental conditions, and current road conditions.

In some embodiments, calculating the distance offset further comprises adjusting the distance offset in accordance with the at least one of the current driver conditions, current passenger conditions, current vehicle operating conditions, current environmental conditions, and current road conditions, such that the adjusted distance offset still results in a lane biasing position commensurate with the lane biasing preference.

In some embodiments, the lane biasing preference reflects a preference based on historical lane biasing positions learned by the vehicle while being operated in one of a manual mode, a semi-autonomous mode, or a fully autonomous mode.

In accordance with another embodiment, a system comprises: a processor; and a memory unit. The memory unit includes instructions that when executed cause the processor to: learn, based on analyzing at least one of current and historical driver or passenger behaviors, a lane biasing preference; calculate a distance offset relative to a current position of the vehicle resulting in a lane biasing position commensurate with the lane biasing preference; and autonomously or semi-autonomously control the vehicle to move from the current position of the vehicle in a lane of travel to the lane biasing position in accordance with the calculated distance offset.

In some embodiments, the instructions, when executed, further cause the processor to store the at least one of the current and historical driver or passenger behaviors in the memory unit as a profile.

In some embodiments, the instructions, when executed, further cause the processor to determine a currently-applicable lane biasing preference by executing a machine learning model for predicting the lane biasing preference in accordance with the at least one of the learned current and historical driver or passenger behaviors.

In some embodiments, the instructions, when executed, further cause the processor to determine, via at least one monitoring device, physical driver characteristics or physical passenger characteristics.

In some embodiments, the instructions, when executed, further cause the processor to determine the currently-applicable lane biasing preference by executing the machine learning model for predicting the lane biasing preference in accordance with the at least one of the learned current and historical driver or passenger behaviors, and adjusted to account for at least one of the physical driver characteristics the physical passenger characteristics, or physical vehicle characteristics.

In some embodiments, the instructions that when executed cause the processor to calculate the distance offset further causes the processor through at least one monitoring device, to perceive at least one of current driver conditions, current passenger conditions, current vehicle operating conditions, current environmental conditions, and current road conditions.

In some embodiments, determining the lane biasing preference further comprises adjusting the lane biasing preference in accordance with the at least one of the current driver conditions, current passenger conditions, current vehicle operating conditions, current environmental conditions, and current road conditions.

In some embodiments, the instructions that when executed cause the processor to calculate the distance offset further causes the processor to adjust the distance offset in accordance with the at least one of the current driver conditions, current passenger conditions, current vehicle operating conditions, current environmental conditions, and current road conditions, such that the adjusted distance offset still results in a lane biasing position commensurate with the lane biasing preference.

In some embodiments, the instructions that when executed cause the processor to learn the lane biasing preference, are executed while the vehicle is being operated in one of a manual mode, a semi-autonomous mode, or a fully autonomous mode.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example autonomous control system that includes a lane keep assist feature.

FIG. 3 illustrates an example of lane keep assistance.

FIG. 4 illustrates an example of lane biasing in accordance with some embodiments of the systems and methods disclosed herein.

FIG. 5 is a flow chart illustrating operations that may be performed to effectuate learned lane biasing in accordance with one embodiment.

FIG. 6 is an example computing component that may be used to implement various features of embodiments described in the present disclosure.

The figures are not exhaustive and do not limit the present disclosure to the precise form disclosed.

### DETAILED DESCRIPTION

As alluded to above, a lane keep assist (LKA) feature helps maintain a vehicle's position within a current lane of travel. Typically, LKA systems can control the lateral/longitudinal movements of a vehicle to stay within a current lane of travel, or even avoid obstacles or objects in the path of the vehicle. Some vehicles can pilot themselves with little to no driver input. Such LKA features/systems may be considered to be part of autonomous vehicle (AV) and semi-autonomous vehicle (SAV) systems that exist for controlling the driving behaviors of a vehicle. Current AV and SAV systems use vehicle control systems to interpret sensory information, to identify appropriate traffic configurations, to decide navigation paths, and to actuate vehicle systems.

Additionally, advanced driver-assistance systems (ADAS), one form of SAV systems, can refer to electronic systems that assist a vehicle operator while driving, parking, or otherwise maneuvering a vehicle. ADAS can increase vehicle and road safety by minimizing human error, and introducing some level of automated vehicle/vehicle feature control. AV systems may go further than ADAS by leaving responsibility of maneuvering and controlling a vehicle to the autonomous driving systems. For example, an autonomous driving system may comprise some package or combination of sensors to perceive a vehicle's surroundings, and advanced control systems that interpret the sensory information to identify appropriate navigation paths, obstacles, road signage, etc., which may then be translated into/provided as instructions to a vehicle's actuators.

However, unless an object or obstacle is blocking/partially blocking a lane, conventional LKA systems tend to position the vehicle in the near exact center of the lane. In other words, the distance to the left lane marker from the left side of the vehicle is substantially equal to the distance to the right lane marker from the right side of the vehicle.

While this positioning within the center of the lane may seem logical from an implementation standpoint, some drivers find this positioning uncomfortable. At least some research reveals that drivers typically bias the positioning of the vehicle within a current lane of travel based on a variety of factors or considerations. Examples of such factors or considerations include, e.g., road type (rural road, expressway, etc.), which lane in a multilane road they are utilizing (e.g., left lane, middle lane, right lane), time of day, weather conditions, presence of static/dynamic objects, etc. Reasons for such lane biasing may be physiological discomfort from driving close to another vehicle. For example, in a multi-lane road, if the driver of a first vehicle finds him/herself next to a second vehicle in a neighboring lane, the driver of the first vehicle may position the first vehicle as far away from the second vehicle while remaining in the first vehicle's current lane of travel. The same may hold true when a portion of roadway comprises a mountain path where one side of the roadway is a steep drop-off. In that type of scenario, the driver may bias the vehicle's positioning in the current lane of travel to be as far away from the edge/side of roadway proximate to the steep drop-off.

Accordingly, embodiments of the present disclosure are directed to lane biasing. Lane biasing can refer to positioning of a vehicle within a current lane of travel. Lane biasing in accordance with various embodiments can be dependent on learned driver behaviors or other factors that may impact lane biasing, e.g., weather conditions, traffic conditions, and so on (which may also be learned). It should be understand that lane biasing may result in a vehicle traveling off the center-line of a current lane of travel. However, lane biasing in accordance with embodiments may also result in the vehicle traveling in the center or near-center of a current lane of travel, but is nevertheless distinguished from conventional LKA systems that merely position a vehicle in the center of a current lane of travel by default. That is, even if lane biasing is effectuated in accordance with various embodiments such that a vehicle ends up traveling in the center or near-center of a lane, the positioning of the vehicle is the result of learned behaviors or other intelligence, rather than merely being a default position (without regard for such considerations).

Embodiments of the present disclosure improve the functionality of AVs/SAVs. As alluded to above, conventional AV/SAV systems will position a vehicle near the center of the lane in which the vehicle is traveling. In contrast, and Instead of applying a one-size-fits-all solution for positioning a vehicle within a lane, embodiments leverage learned information, e.g., a driver's habits regarding lane positioning. Embodiments of the present disclosure may then implement those habits/use those habits as a basis for guiding the vehicle when operating in an autonomous/semi-autonomous mode.

Accordingly, a lane biasing system in accordance with various embodiments learns how a particular driver biases a vehicle's position within a lane by observing the driver's driving habits. The manner in which learning occurs can vary. For example, the lane biasing system may simply learn the overall preferred positioning of a vehicle within a lane, e.g., based on historical tendencies of that particular driver/that particular driver when operating a particular vehicle, etc. That is, some drivers may generally bias the vehicle's position slightly to the right of the center of a lane, while other drivers may bias the vehicle's position slightly to the left of the center of the lane. However, in other embodiments (or depending on how the lane biasing system is configured to operate) the lane biasing system may monitor and collect information regarding multiple, different scenarios involving how the driver positions the vehicle within a lane. These different scenarios can include road type, position within multilane roads, time of day, weather conditions, presence of static/dynamic objects, etc.

In some embodiments, the observation of, and the learning from a driver's driving patterns may occur when the driver is operating the vehicle in a non-autonomous mode or semi-autonomous mode (i.e., modes in which the driver is at least partially controlling the position of the vehicle within a lane). Based on these observed driving patterns or behaviors, the lane biasing system may modify the vehicle's autonomous/semi-autonomous operating modes to mimic these patterns.

In other embodiments, the observation of, and the learning from a driver's driving patterns may occur even when the vehicle is operating in an autonomous mode. For example, current vehicles capable of (fully) autonomous operation still may have control elements/actuators that can receive human (driver) input. Thus, a vehicle may still have actuatable controls/elements, such as steering wheels, brake pedals, accelerator pedals, etc., but may be operated in an autonomous mode. For example, movement of the steering wheel is controlled by the vehicle's AV system rather then by driver input. While operating in an autonomous mode, however, a driver may still try to control operation of the vehicle. In such an instance, the driver-input control(s) may be ignored or overridden by the vehicle's AV system, and instead observed as a driver preference/behavior/habit that can still be used to teach the lane biasing system in accordance with some embodiments.

It should be noted that under certain circumstances, learning lane bias preferences may be easier to accomplish while a vehicle is operating in fully autonomous mode. That is, when attempting to ascertain a driver's lane biasing preferences, drivers tend to exhibit “stronger” signals when attempting to override autonomous control. When the autonomous/semi-autonomous is active, determination unit 214, for example, may have an easier time distinguishing between driver lane biasing preferences and the continuous small adjustments drivers typically make when operating a vehicle.

Even without actuatable elements or controls (or in addition to learning from driver interaction with such elements/controls), internal sensors (discussed in greater detail below) may observe/sense passenger reactions to positioning of a vehicle (non-autonomous/semi-autonomous/fully autonomous) in a current lane of travel. For example, when a vehicle is traveling in the center of a lane, a passenger(s) may shy away from or lean away from one side of the vehicle. This may be taken as a signal that the passenger(s) is/are uncomfortable with the proximity of some neighboring vehicle (on the side of the vehicle opposite the direction of leaning). Over time, this may be determined/learned to be a habit or persistent behavior, and may be used to teach the lane biasing system to bias the vehicle away from a neighboring vehicle and offset from the center of the lane being traveled.

It should be noted that the behavioral patterns that are observed need not necessarily reflect some movement of a vehicle away from one side of a lane in which a vehicle is current traveling to another side of that lane, offset from the center of the lane. For example, instead of a driver moving a vehicle further to one side of a lane, the driver may perform some other operation that over time, can be determined (through known data analytics or machine learning/artificial intelligence mechanism) to be indicative of a driver's (or passenger's) tendencies, which in turn can be translated into an actual lane biasing preference. For example, when a driver is operating a first vehicle, and a second vehicle approaches the first vehicle and begins traveling side-by-side with the first vehicle, the driver may simply apply the brakes in the first vehicle. Over time, e.g., repeated instances of braking in a neighboring vehicle scenario, the lane biasing system may determine that the driver's preference is to not be close to another vehicle. Accordingly, when the lane biasing system encounters the same/similar scenario in which a driver previously exhibited a tendency to brake, the lane biasing system may bias the position of the vehicle away from the center of the lane and away from the neighboring vehicle.

Although the lane biasing system may perform such biasing under any circumstances, in some instances, lane biasing as opposed to merely braking may be preferable. That is, a vehicle may be flanked by multiple vehicles, and if a vehicle of interest is preceding a following vehicle, braking may not be a safe option. Accordingly, the lane biasing system will position the vehicle in a biased manner within the lane to account for the learned driver/passenger discomfort of a traveling side-by-side to another vehicle.

As alluded to above, in some instances, the lane biasing system may control a vehicle such that the vehicle positions itself at or near the center of a lane. For example, a scenario may exist, whereby despite a driver's learned preferences/behaviors warranting lane biasing to one side of a lane or another, safety reasons may be considered by the lane biasing system. Such safety considerations may dictate that lane biasing may not be a preferred option, e.g., a driver's observed tendency to bias a vehicle's position away from the side of a drop-off and a tendency to bias a vehicle's position away from a neighboring vehicle cancel each other out.

The systems and methods disclosed herein may be implemented with or by any of a number of different vehicles and vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle is illustrated and described below as one example.

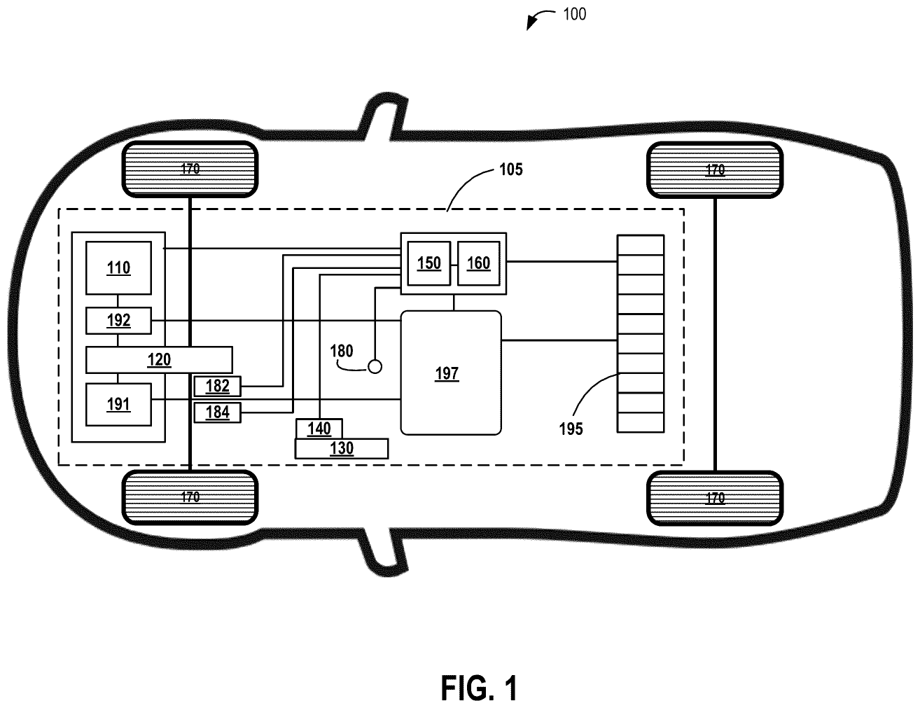

FIG. 1 illustrates an example hybrid electric vehicle (HEV) 100 in which various embodiments for driver disengagement of autonomous vehicle/driving controls may be implemented. It should be understood that various embodiments disclosed herein may be applicable to/used in various vehicles (internal combustion engine (ICE) vehicles, fully electric vehicles (EVs), etc.) that are fully or partially autonomously controlled/operated, not only HEVs.

HEV 100 can include drive force unit 105 and wheels 170. Drive force unit 105 may include an engine 110, motor generators (MGs) 191 and 192, a battery 195, an inverter 197, a brake pedal 130, a brake pedal sensor 140, a transmission 120, a memory 160, an electronic control unit (ECU) 150, a shifter 180, a speed sensor 182, and an accelerometer 184.

Engine 110 primarily drives the wheels 170. Engine 110 can be an ICE that combusts fuel, such as gasoline, ethanol, diesel, biofuel, or other types of fuels which are suitable for combustion. The torque output by engine 110 is received by the transmission 120. MGs 191 and 192 can also output torque to the transmission 120. Engine 110 and MGs 191 and 192 may be coupled through a planetary gear (not shown in FIG. 1B). The transmission 120 delivers an applied torque to the wheels 170. The torque output by engine 110 does not directly translate into the applied torque to the wheels 170.

MGs 191 and 192 can serve as motors which output torque in a drive mode, and can serve as generators to recharge the battery 195 in a regeneration mode. The electric power delivered from or to MGs 191 and 192 passes through inverter 197 to battery 195. Brake pedal sensor 140 can detect pressure applied to brake pedal 130, which may further affect the applied torque to wheels 170. Speed sensor 182 is connected to an output shaft of transmission 120 to detect a speed input which is converted into a vehicle speed by ECU 150. Accelerometer 184 is connected to the body of HEV 100 to detect the actual deceleration of HEV 100, which corresponds to a deceleration torque.

Transmission 120 is a transmission suitable for an HEV. For example, transmission 120 can be an electronically controlled continuously variable transmission (ECVT), which is coupled to engine 110 as well as to MGs 191 and 192. Transmission 120 can deliver torque output from a combination of engine 110 and MGs 191 and 192. The ECU 150 controls the transmission 120, utilizing data stored in memory 160 to determine the applied torque delivered to the wheels 170. For example, ECU 150 may determine that at a certain vehicle speed, engine 110 should provide a fraction of the applied torque to the wheels while MG 191 provides most of the applied torque. ECU 150 and transmission 120 can control an engine speed (N_{E}) of engine 110 independently of the vehicle speed (N_{V}).

ECU 150 may include circuitry to control the above aspects of vehicle operation. ECU 150 may include, for example, a microcomputer that includes a one or more processing units (e.g., microprocessors), memory storage (e.g., RAM, ROM, etc.), and I/O devices. ECU 150 may execute instructions stored in memory to control one or more electrical systems or subsystems in the vehicle. ECU 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS), electronic parking brake (EPB), or electronic stability control (ESC)), battery management systems, and so on. These various control units can be implemented using two or more separate electronic control units, or using a single electronic control unit.

MGs 191 and 192 each may be a permanent magnet type synchronous motor including for example, a rotor with a permanent magnet embedded therein. MGs 191 and 192 may each be driven by an inverter controlled by a control signal from ECU 150 so as to convert direct current (DC) power from battery 195 to alternating current (AC) power, and supply the AC power to MGs 191, 192. MG 192 may be driven by electric power generated by motor generator MG191. It should be understood that in embodiments where MG191 and MG192 are DC motors, no inverter is required. The inverter, in conjunction with a converter assembly may also accept power from one or more of MGs 191, 192 (e.g., during engine charging), convert this power from AC back to DC, and use this power to charge battery 195 (hence the name, motor generator). ECU 150 may control the inverter, adjust driving current supplied to MG 192, and adjust the current received from MG191 during regenerative coasting and braking.

Battery 195 may be implemented as one or more batteries or other power storage devices including, for example, lead-acid batteries, lithium ion, and nickel batteries, capacitive storage devices, and so on. Battery 195 may also be charged by one or more of MGs 191, 192, such as, for example, by regenerative braking or by coasting during which one or more of MGs 191, 192 operates as generator. Alternatively (or additionally, battery 195 can be charged by MG 191, for example, when HEV 100 is in idle (not moving/not in drive). Further still, battery 195 may be charged by a battery charger (not shown) that receives energy from engine 110. The battery charger may be switched or otherwise controlled to engage/disengage it with battery 195. For example, an alternator or generator may be coupled directly or indirectly to a drive shaft of engine 110 to generate an electrical current as a result of the operation of engine 110. Still other embodiments contemplate the use of one or more additional motor generators to power the rear wheels of a vehicle (e.g., in vehicles equipped with 4-Wheel Drive), or using two rear motor generators, each powering a rear wheel.

Battery 195 may also be used to power other electrical or electronic systems in the vehicle. Battery 195 can include, for example, one or more batteries, capacitive storage units, or other storage reservoirs suitable for storing electrical energy that can be used to power MG 191 and/or MG 192. When battery 195 is implemented using one or more batteries, the batteries can include, for example, nickel metal hydride batteries, lithium ion batteries, lead acid batteries, nickel cadmium batteries, lithium ion polymer batteries, and other types of batteries.

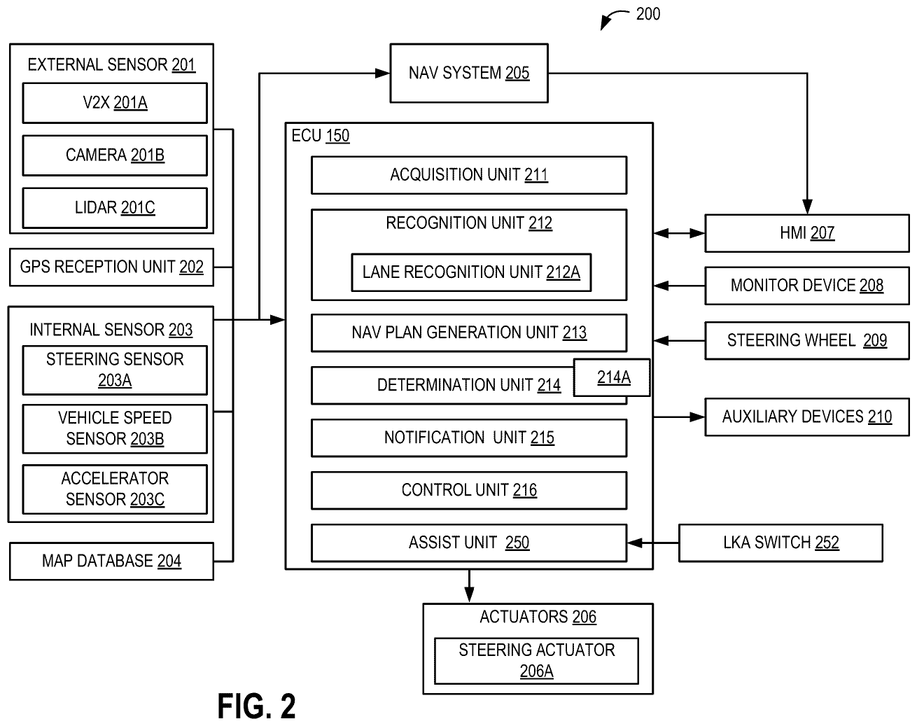

FIG. 2 illustrates an example autonomous control system 200 that may be used to autonomously control a vehicle, e.g., HEV 100. Autonomous control system 200 may be installed in HEV 100, and executes autonomous control of HEV 100. As described herein, autonomous control can refer to control that executes driving/assistive driving operations such as acceleration, deceleration, and/or steering of a vehicle, generally movement of the vehicle, without depending or relying on driving operations/directions by a driver or operator of the vehicle.

As an example, autonomous control may include LKA control where a steering wheel 209 is steered automatically (namely, without depending on a steering operation by the driver) such that HEV 100 does not depart from a running lane. That is, the steering wheel is automatically operated/controlled such that HEV 100 runs along the running lane, even when the driver does not perform any steering operation.

As another example, autonomous control may include navigation control, where when there is no preceding vehicle in front of the HEV 100, constant speed (cruise) control is effectuated to make HEV 100 run at a predetermined constant speed. When there is a preceding vehicle in front of HEV 100, follow-up control is effectuated to adjust HEV 100's speed according to a distance between HEV 100 and the preceding vehicle.

In some scenarios, switching from autonomous control to manual driving may be executed. For example, when an operation amount of any of a steering operation, an acceleration operation, and brake operation by the driver of HEV 100 during the autonomous driving control becomes equal to or more than a threshold, autonomous control system 200 may execute a switch from autonomous control to manual control.

It should be understood that manual control or manual driving can refer to a vehicle operating status wherein a vehicle's operation is based mainly on driver-controlled operations/maneuvers. In an ADAS/SAV context, driving operation support control can be performed during manual driving. For example, a driver may be actively performing any of a steering operation, an acceleration operation, and a brake operation of the vehicle, while autonomous control system 200 performs some subset of one or more of those operations, e.g., in an assistive, complementary, or corrective manner. As another example, driving operation support control adds or subtracts an operation amount to or from the operation amount of the manual driving (steering, acceleration, or deceleration) that is performed by the driver.

In the example shown in FIG. 2, autonomous control system 200 is provided with an external sensor 201, a GPS (Global Positioning System) reception unit 202, an internal sensor 203, a map database 204, a navigation system 205, actuators 206, an HMI (Human Machine Interface) 207, a monitor device 208, a steering wheel 209, auxiliary devices 210, an assist unit 250, and an LKA switch 252. Autonomous control system 200 may communicate with ECU 150, or in some embodiments (may be implemented with its own ECU).

In the example shown in FIG. 2, external sensor 201 is a detector that detects external circumstances such as surrounding information of HEV 100. The external sensor 201 may include a camera 210B, a Laser Imaging Detection and Ranging (LIDAR) unit 201C, and a vehicle-to-everything (V2X) receiver 201A. Other sensors may be included as an external sensor 201, e.g., a radar unit.

The camera 201B may be an imaging device that images the external circumstances surrounding the vehicle. For example, the camera is provided on a back side of a front windshield of the vehicle. The camera may be a monocular camera or a stereo camera. The camera 201B outputs, to the ECU 150, image information on the external circumstances surrounding the vehicle, image information/characteristics of a road/portion of roadway ahead of a vehicle or behind the vehicle (depending on camera 201B placement). The camera 201B is not limited to a visible light wavelength camera but can be an infrared camera.

The LIDAR unit 201C uses light waves to detect obstacles outside of the vehicle by transmitting light waves to the surroundings of the vehicle, and receiving reflected light waves from an obstacle to detect the obstacle, distance to the obstacle or a relative positional direction of the obstacle. The LIDAR unit outputs detected obstacle information to the ECU 150.

A V2X receiver 210A may be a radio or other electronic device including a transmitter or receiver operable to send/receive wireless messages using any V2X communications protocol. Examples of V2X protocols include, but are not limited to, e.g., dedicated short-range communication (DSRC), Long Term Evolution (LTE), millimeter wave communication, 5G-V2X, and so on. Almost any type or kind of information/data may be sent/received via V2X communications. For example, traffic information, road conditions information, weather information, neighboring vehicle information, etc. may be transmitted from a roadside unit to a vehicle, from one vehicle to another vehicle, and so on.

In the example shown in FIG. 2, GPS reception unit 202 receives signals from three or more GPS satellites to obtain position information indicating a position of HEV 100. For example, the position information can include latitude information and longitude information. The GPS reception unit 202 outputs the measured position information of the vehicle to the ECU 150.

In the example shown in FIG. 2, the internal sensor 203 can refer to a detector(s) for detecting information regarding, e.g., a running status of HEV 100, operational/operating conditions, e.g., amount of steering wheel actuation, rotation, angle, amount of acceleration, accelerator pedal depression, brake operation by the driver of HEV 100. The internal sensor 203 includes at least one of a vehicle speed sensor 203B, an accelerator (pedal) sensor 203C, a brake (pedal) sensor 203A, and other sensors, e.g., accelerometers such as a 3-axis accelerometer to detect roll, pitch, and yaw of HEV 100 (e.g., to detect vehicle heading), a steering sensor, an acceleration sensor (not shown, but well-understood in the art), etc.

Vehicle speed sensor 203B is a detector that detects a speed of the HEV 100. In some embodiments, HEV 100's speed may be measured directly or through calculations/inference depending on the operating conditions/status of one or more other components of HEV 100. For example, a wheel speed sensor can be used as the vehicle speed sensor 203B to detect a rotational speed of the wheel, which can be outputted to ECU 150.

The acceleration sensor can be a detector that detects actuation of an accelerator pedal (or other accelerator actuator) of HEV 100. For example, the acceleration sensor may include a longitudinal acceleration sensor for detecting a longitudinal acceleration of HEV 100, and a lateral acceleration sensor for detecting a lateral acceleration of HEV 100. The acceleration sensor outputs, to the ECU 150, acceleration information.

The yaw rate sensor can be a detector that detects a yaw rate (rotation angular velocity) around a vertical axis passing through the center of gravity of HEV 100. For example, a gyroscopic sensor is used as the yaw rate sensor. The yaw rate sensor outputs, to the ECU 150, yaw rate information including the yaw rate of HEV 100.

The steering sensor 203A may be a detector that detects an amount of a steering operation/actuation with respect to a steering wheel 30 by the driver of HEV 100. The steering operation amount detected by the steering sensor 203A may be a steering angle of the steering wheel or a steering torque applied to the steering wheel, for example. The steering sensor 203A outputs, to the ECU 150, information including the steering angle of the steering wheel 209 or the steering torque applied to the steering wheel 209 of HEV 100.

The accelerator sensor 203C may be a detector that detects a stroke amount of an accelerator pedal, for example, a pedal position of the accelerator pedal with respect to a reference position. The reference position may be a fixed position or a variable position depending on a determined parameter. The accelerator sensor 203C is provided on a shaft portion of the accelerator pedal of the vehicle, for example. The accelerator sensor 203C outputs, to the ECU 150, operation information reflecting the stroke amount of the accelerator pedal.

The brake sensor 203A may be a detector that detects a stroke amount of a brake pedal, for example, a pedal position of the brake pedal with respect to a reference position. Like the accelerator position, a brake pedal reference position may be a fixed position or a variable position depending on a determined parameter. The brake sensor 203A may detect an operation force of the brake pedal (e.g. force on the brake pedal, oil pressure of a master cylinder, and so on). The brake sensor 203A outputs, to the ECU 150, operation information reflecting the stroke amount or the operation force of the brake pedal.

A map database 204 may be a database including map information, such as, e.g., what is known in the art as a high definition or high density (HD) map. The map database 204 is implemented, for example, in a disk drive or other memory installed in HEV 100. The map information may include road position information, road shape information, intersection position information, and fork position information, for example. The road shape information may include information regarding a road type such as a curve and a straight line, and a curvature angle of the curve. When autonomous control system 200 uses a Simultaneous Localization and Mapping (SLAM) technology or position information of blocking structural objects such as buildings and walls, the map information may further include an output signal from external sensor 201. In some embodiments, map database 204 may be a remote data base or repository with which HEV 100 communicates.

Navigation system 205 may be a component or series of interoperating components that guides the driver of HEV 100 to a destination on a map designated by the driver of HEV 100. For example, navigation system 205 may calculate a route followed or to be followed by HEV 100, based on the position information of HEV 100 measured by GPS reception unit 202 and map information of map database 204. The route may indicate a running lane of a section(s) of roadway in which HEV 100 traverses, for example. Navigation system 205 calculates a target route from the current position of HEV 100 to the destination, and notifies the driver of the target route through a display, e.g., a display of a head unit, HMI 207 (described below), and/or via audio through a speaker(s) for example. The navigation system 205 outputs, to the ECU 150, information of the target route for HEV 100. In some embodiments, navigation system 205 may use information stored in a remote database, like map database 204, and/or some information processing center with which HEV 100 can communicate. A part of the processing executed by the navigation system 205 may be executed remotely as well.

Actuators 206 may be devices that execute running controls of HEV 100. The actuators 206 may include, for example, a throttle actuator, a brake actuator, and a steering actuator, such as steering actuator 206A. For example, the throttle actuator controls, in accordance with a control signal output from the ECU 150, an amount by which to open the throttle of HEV 100 to control a driving force (the engine) of HEV 100. In another example, actuators 206 may include one or more of MGs 191 and 192, where a control signal is supplied from the ECU 150 to MGs 191 and/or 192 to output motive force/energy. The brake actuator controls, in accordance with a control signal output from the ECU 150, the amount of braking force to be applied to each wheel of the vehicle, for example, by a hydraulic brake system. The steering actuator 206A controls, in accordance with a control signal output from the ECU 150, driving an assist motor of an electric power steering system that controls steering torque.

HMI 207 may be an interface used for communicating information between a passenger(s) (including the operator) of HEV 100 and autonomous control system 200. For example, the HMI 207 may include a display panel for displaying image information for the passenger(s), a speaker for outputting audio information, and operation buttons or a touch panel used by the occupant for performing an input operation. HMI 207 may also or alternatively transmit the information to the passenger(s) through a mobile information terminal connected wirelessly and receive the input operation by the passenger(s) through the mobile information terminal. In some embodiments, HMI 207 may output some form of haptic feedback in the form of vibrations or other sensory indicia, e.g., to alert a driver that HEV 100 is about to veer outside a current lane of travel.

Monitor device 208 monitors a status of the driver/operator. The monitor device 208 can check a manual driving preparation state of the driver. More specifically, the monitor device 208 can check, for example, whether or not the driver is ready to start manual operation of HEV 100. Moreover, the monitor device 208 can check, for example, whether or not the driver has some intention of switching HEV 100 to a manual mode of operation, or if LKA switch 252 has been engaged or disengaged. As will be described in greater detail below, monitor device 208 may provide information or data, e.g., statistical data, characterizing preferred operating characteristics of a driver across a variety of timelines, e.g., while traversing a particular route, while operating HEV 100 during a particular period of time, season/weather condition (more aggressive operation during dry conditions as compared to more cautious operation during rainy conditions), etc.

For example, the monitor device 208 may be a camera that can take an image of the driver, where the image can be used for estimating the degree to which the driver's eyes are open, the direction of the driver's gaze, whether or not the driver is holding the steering wheel, etc. Monitor device 208 may also be a pressure sensor for detecting the amount of pressure the driver's hand(s) are applying to the steering wheel. As another example, the monitor device 208 can be a camera that takes an image of a hand of the driver. It should be understood that other sensors, e.g., accelerator sensor 203C, may be leveraged to obtain information characterizing the driving habits or preferences of a driver. Although accelerator sensor 203C does not sense any characteristic of the driver him/herself, the resulting operation of HEV 100, such as how often or how aggressive acceleration is performed can be indicative of a driver's behavior or driving preferences.

A steering wheel 209 can be a traditional steering wheel or other direction control device that may be actuated to pilot the vehicle in a particular lateral direction, whether the vehicle is progressing in a forward or rearward direction. In manually operated vehicles or SAVs, steering wheel 209 may be used by a driver to effectuate directional control of the vehicle. In AVs or vehicle capable of selective autonomous operation, steering wheel 209 may be present, although actuation of steering wheel 209 may be ignored/overridden by the vehicles AV system.

Auxiliary devices 210 may include devices that can be operated by the driver of the vehicle, but are not necessarily drive-related, such as actuators 206. For example, auxiliary devices 210 may include a direction indicator, a headlight, a windshield wiper and the like.

ECU 150 may execute autonomous control of the vehicle, and may include an acquisition unit 211, a recognition unit 212, a navigation plan generation unit 213, a calculation unit 214, a presentation unit 215, and a control unit 216.

Acquisition unit 211 may obtain the following operation amounts or levels of actuation based on the information obtained by the internal sensor 203: steering operation, acceleration operation, and brake operation by the driver during an autonomous control mode; and the level of steering operation, acceleration operation, and brake operation by the driver of the vehicle during a manual control mode.

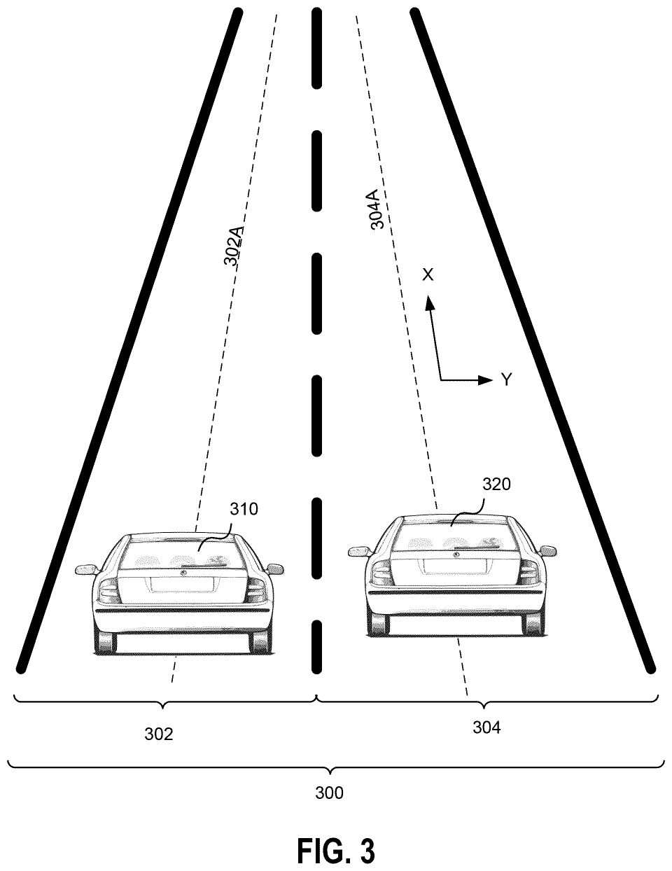

In some embodiments, based on the position of HVE 100 and the map information, acquisition unit 211 acquires the positional or other relevant information about lanes in the road-extending direction (for example, the direction indicated by arrow X in FIG. 3) on the road on which HEV 100 is traveling, and lane information in the road-width direction (for example, the direction indicated by an arrow Y in FIG. 3). Acquisition unit 211 may acquire positional information about the number of lanes comprising a road being traversed by HEV 100, lane characteristics (lane width, particular lane traversal instructions, e.g., a turn-only lane, etc.). Acquisition unit 211 may acquire lane information such as relative lane position, e.g., as it affects driver behavior. That is, in some areas/jurisdictions, applicable rules of the road dictate that slower traffic move to/remain in a rightmost lane of a roadway, while faster traffic move to/remain in a leftmost lane of a roadway. Acquisition unit 211 can acquire the position of HEV 100 based on the positioning result provided from the GPS reception unit 202. Acquisition unit 211 acquires map information from map database 204 (or from navigation system 205). Acquisition unit 211 acquires the positional information and lane information about the lane increase-decrease area present on the road ahead of HEV 100 in its traveling direction. Acquisition unit 211 may acquire the positional information and lane information within a predetermined distance from the current position of HEV 100 in its traveling direction.

Recognition unit 212 may recognize or assess the environment surrounding or neighboring HEV 100 based on the information obtained by the external sensor 201, the GPS reception unit 202, and/or the map database 204. For example, the recognition unit 212 includes an obstacle recognition unit (not shown), a road width recognition unit (not shown), a facility recognition unit (not shown), and a lane recognition unit 212A. The obstacle recognition unit recognizes, based on the information obtained by the external sensor 201, obstacles surrounding the vehicle. For example, the obstacles recognized by the obstacle recognition unit include moving objects such as pedestrians, other vehicles, motorcycles, and bicycles and stationary objects such as a road lane boundary (white line, yellow line), a curb, a guard rail, poles, a median strip, buildings and trees. The obstacle recognition unit obtains information regarding a distance between the obstacle and the vehicle, a position of the obstacle, a direction, a relative velocity, a relative acceleration of the obstacle with respect to the vehicle, and a category and attribution of the obstacle. The category of the obstacle includes a pedestrian, another vehicle, a moving object, and a stationary object. The attribution of the obstacle can refer to a property of the obstacle such as hardness and a shape of the obstacle.

The facility recognition unit recognizes, based on the map information obtained from the map database 204 and/or the vehicle position information obtained by the GPS reception unit 202, whether or not HEV 100 is operating/being driven through an intersection, in a parking structure, etc. The facility recognition unit may recognize, based on the map information and the vehicle position information, whether or not the vehicle is running in a school zone, near a childcare facility, near a school, or near a park, etc.

In some embodiments, lane recognition unit 212A recognizes the lane in which HEV 100 is traveling (current lane of travel), on the road on which HEV 100 is traveling. That is, the lane recognition unit 212A recognizes the lane in which HEV 100 is traveling, in a road including a plurality of lanes. Lane recognition unit 212A recognizes the current lane of travel by any known method, based on, for example, an image of the road ahead HEV 100 captured by camera 201B. Specifically, for example, the lane recognition unit 212A recognizes the white lines of the road ahead of HEV 100 through image analysis, based on an image of the road ahead HEV 100 captured by the camera 201B. The lane recognition unit 212A can recognize the lane in which HEV 100 is traveling, based on, for example, the number of the recognized white lines on the road, and the positional relationship between the white lines and HEV 100. In some cases, the information about the number of white lines provided on a road, the kinds of the white lines, and the number of lanes, is included in the map information stored in map database 204. It should be understood that recognizing lane characteristics can be premised on different indicators/indicia beyond white lines, e.g., yellow lines, road signs, traffic signals (arrow traffic signals), and so on.

Navigation plan generation unit 213 may generate a navigation plan for HEV 100 based on the target route calculated by the navigation system 205, the information on obstacles surrounding HEV 100 recognized by recognition unit 212, and/or the map information obtained from map database 204. The navigation plan may be reflect one or more operating conditions/controls to effectuate the target route. For example, the navigation plan can include a target speed, a target acceleration, a target deceleration, a target direction, and/or a target steering angle with which HEV 100 should be operated at any point(s) along the target route so that the target route can be achieved to reach a desired destination. It should be understood that navigation plan generation unit 213 generates the navigation plan such that HEV 100 operates along the target route while satisfying one or more criteria and/or constraints, including, for example, safety constraints, legal compliance rules, operating (fuel/energy) efficiency, and the like. Moreover, based on the existence of obstacles surrounding HEV 100, the navigation plan generation unit 213 generates the navigation plan for the vehicle so as to avoid contact with such obstacles.

Presentation unit 215 displays, on a display of the HMI 207, a threshold which is calculated by the calculation unit 214 and used for determining whether or not to execute the switching from autonomous control to the manual driving or vice versa.

Control unit 216 can autonomously control HEV 100 based on the navigation plan generated by navigation plan generation unit 213. The control unit 216 outputs, to the actuators 206, control signals according to the navigation plan. That is, the control unit 216 controls actuators 206 based on the navigation plan, and thereby autonomous control of HEV 100 is executed/achieved. Control unit 216 may autonomously or semi-autonomously control HEV 100 based on other information, e.g., sensor information from external sensor 201 or internal sensor 203, or depending on lane characteristics (gleaned from lane recognition unit 212A), or monitor device 208 (such as driver preferences), or other information from recognition unit 212 (such as obstacle information, neighboring vehicle information, road characteristics information, etc.).

In some embodiments, data collection can comprise monitoring the operation of autonomous control system or aspects thereof, e.g., control unit 216 over time. Thus, the aforementioned data/information that is stored/logged can include time-series data involving some subset of or all aspects of autonomous control system 200. For example, commands from control unit 216 to actuators 206 may be monitored, and time-series data representative of the operating states/conditions of control unit 216 may be captured.

Assist unit 250 provides lane keeping assistance for assisting driving of HEV 100 such that HEV 100 travels along or within a current or appropriate lane of travel. Specifically, assist unit 250 starts lane keeping assistance in response to, for example, a switch operation performed by the driver (i.e., actuation of LKA switch 252). Assist unit 250 recognizes relevant lane indicators or boundaries, e.g., the white line(s) of the lane in which the HEV 100 is traveling, through image analysis based on, for example, an image of a road ahead of HEV 100 captured by camera 201B. Assist unit 250 recognizes the lateral position of HEV 100 in the current lane of travel based on, for example, the positions of the white lines perceived in the captured image.

Next, assist unit 250 controls traveling of the HEV 100 by applying steering torque to steering wheel 209 of HEV 100 (by way of a signal(s) or instruction(s) transmitted by assist unit 250 to control unit 216, which may then send a corresponding control signal(s) or instruction(s) to actuators 206, in particular, steering actuator 206A) such that the recognized lateral position of HEV 100 is adjusted to a target lateral position, which in various embodiments, comprises a lane bias or offset distance relative to a center (or central range) of the current lane of travel.

Determination unit 214 may calculate a threshold used for determining whether or not to switch from autonomous control to manual driving or vice versa. The determination can be performed based on the operating levels associated with the manner in which the driver is operating HEV 100 during autonomous control which is obtained by the acquisition unit 211. For example, the driver of HEV 100 may suddenly grasp the steering wheel (which can be sensed by internal sensor 203) and stomp on the brake pedal (which can be sensed by monitor device 208). The pressure on the steering wheel and the level of actuation of the brake pedal may be excessive enough (exceed a threshold) suggesting that the driver intends to override the autonomous control system 200.

Determination unit 214 may also determine where to position HEV 100 vis-h-vis control unit 216/assist unit 250. It should be understood that the lane biasing system disclosed herein may comprise one or more elements of autonomous control system 200 that operate to determine how/when to perform lane biasing, as well as the controls used to effectuate that lane biasing. For example, as will be described in greater detail below, driver behavior patterns or tendencies may be observed by external sensor 201 or external sensor 203. Based on information relevant to the operation of the vehicle, e.g., from those same sensor(s), GPS reception unit 202, map database 204, acquisition unit 211, monitor device 208, etc. Driver or passenger profiles characterizing observed/learned driver/passenger behavior or tendencies may be stored in a memory, here shown as memory 214A. In other embodiments, determination unit 214 may access some other memory or data repository, e.g., a remote data repository in which observed driver/passenger information may be maintained.

In some embodiments, determination unit 214 may, based on a driver profile of the driver operating HEV 100, determine a lane bias position to which HEV 100 may be directed. In some embodiments, assist unit 250 may effectuate conventional LKA, but adjusted or adapted in light of determined lane bias position output by determination unit 214. That is, based on instructions or signals from determination unit 214 that are transmitted to assist unit 250, assist unit 250 may generate corresponding signals or instructions for applying an appropriate amount of steering torque in an appropriate direction based on the driver profile lane bias position determined by determination unit 214, and based on a current position of HEV 100 in the current lane of travel. For example, internal sensor 203, which as described above, includes at least one of a vehicle speed sensor 203B, an accelerator (pedal) sensor 203C, a brake (pedal) sensor 203A, and other sensors, e.g., accelerometers such as a 3-axis accelerometer to detect roll, pitch, and yaw of HEV 100 (e.g., to detect vehicle heading). Thus, the aforementioned instructions or signals transmitted to assist unit 250 instruct assist unit 250 to apply the appropriate amount of steering torque in the appropriate direction to guide HEV 100 to the desired lane bias position from it's current position in the current lane of travel detected by internal sensor 203. Accordingly, assist unit 250 may transmit instructions or signals to control unit 216 to effectuate the appropriate amount of steering torque in the appropriate direction. In turn, control unit 216 may send corresponding instructions or signals to actuators 206, in particular, steering actuation 206A.

In other embodiments, determination unit 214 may again determine a lane bias position to which HEV 100 may be directed. Thereafter, determination unit 214 may, based on a current position of HEV 100 in the current lane of travel, and depending on the detected vehicle heading vis-à-vis internal sensor 203, transmit instructions or signals to assist unit 250 to apply an appropriate amount of steering torque in an appropriate direction that results in positioning HEV 100 at the desired lane bias position. Accordingly, assist unit 250 may transmit instructions or signals to control unit 216 to effectuate the appropriate amount of steering torque in the appropriate direction. In turn, control unit 216 may send corresponding instructions or signals to actuators 206, in particular, steering actuation 206A.

It should be noted that determination unit 214 may comprise data analytical/learning components or functionality such that the observed driver/passenger behaviors may be analyzed to characterize lane biasing preferences/behaviors of the driver/passenger. Such profiles/information may be linked to a user and accessed by determination unit 214, e.g., upon associating a key fob used by a driver with HEV 100, for example (although a person of ordinary skill in the art would understand how to associate a user (driver/passenger) profile or information with a particular vehicle being operated or used by that user. In some embodiments, the analytics/learning functionality may be implemented remotely, e.g., at a remote processing server(s), and simply downloaded to ECU 150 as needed/appropriate. A profile may comprise any compilation(s) or set(s) of data characterizing or representing learned preferences/behaviors of a driver regarding lane biasing. For example, a profile may comprise a table or other data set(s) associating particular road characteristics, weather conditions, obstacle characteristics, thresholds for determining whether or not to lane bias or by how much, traffic conditions, and so on or sets of such information with particular distance offsets (described below). In some embodiments, a profile may comprise or involve determination unit 214 iterating through a decision tree, where different nodes/branches of the decision tree comprise conditions/characteristics such as those described above, until a target or desired distance offset is determined. It should be understood that any known or future-discovered manner of reflecting driver/passenger preferences whether by a profile or other mechanism, can be used. For example, a linear model, whereby preferred lane biasing may be a function of positioning of a neighboring vehicle, for example, plus a weight value assigned to such condition/factor, can be used to determine how to lane bias a vehicle during a particular circumstance or scenario.

In terms of implementing or utilizing a particular profile, users, e.g., drivers or passengers with associated profiles can indicate to assist unit 250/determination unit 214 that their particular profile should be referenced by actuating a button in the vehicle, via a key fob linked to the vehicle and their particular profile, etc.

It should also be noted that while autonomous control system 200 is described in the context of various elements or components performing certain operations, the functionality of autonomous control system 200 and that of its elements/components can be implemented in a variety of ways. For example, more or less elements/components may be used to perform the functions/operations described herein. For example, the functionality of recognition unit 212 and assist unit 250 may be combined in some embodiments.

In conventional LKA systems, the target lateral position may be set to, for example, the central area of the traveling lane. Referring to FIG. 3, an example representation of a roadway, road 300, is illustrated. It can be appreciated from FIG. 3 that road 300 comprises two lanes of travel in the X direction, lane 302 and lane 304. FIG. 3 is a non-limiting example of road/travel scenario. As discussed above, lane recognition unit 212A may determine that road 300 comprises two lanes by virtue of an image of road 300 captured by camera 201B. Of course, the type of road, the number of lanes, direction(s) of traffic, etc. may be similarly determined vis-à-vis image capture, or alternatively/additionally, using known information from map database 204, from other external sensors 201.

Additionally, recognition unit 211 may determine the width of road 300, e.g., the Y dimension, as well as the dimension(s), e.g., width, of lanes 302 and 304. Such information may be transmitted to assist unit 250, which may then calculate central areas/regions of lanes 302 and 304. For example, assist unit 250 may perform one or more calculations upon receiving roadway and lane widths from recognition unit 212/lane recognition unit 212A. For example, assist unit 250, may calculate the central portion of lanes 302 and 304 by dividing each width value by two. In other embodiments, the center of lanes 302 and 304 (302A and 304A, respectively) may be known vis-à-vis an HD map from map database 204. Those of ordinary skill in the art would know how to determine a central area/region of a lane(s). As described above, assist unit 250 and control unit 216 may operate to effectuate positioning HEV 100 accordingly.

As illustrated in FIG. 3, and as described above, conventional LKA systems position vehicles in the center or near-center region of a lane. For example, vehicle 320, may according to conventional LKA system operation, position itself at or about at the center of lane 304, i.e., commensurate with center region 304A. However, positioning a vehicle centrally in a current lane of travel may not be desirable to drivers/passengers. For example, assist unit 250 may determine a road type of a road being traveled by vehicle 320. Assist unit 250 may obtain such information from map database 204, and in this example, may determine that road 300 is classified as a two-lane road (two-lane in this example referring to two lanes along the same direction of travel). The information from map database 204 may further include information indicating that faster traffic tends to travel in the left lane, i.e., lane 302, while slower traffic tends to travel in the right lane, i.e., lane 304. Moreover, determination unit 214 may access memory 214A to obtain a relevant driver profile of the driver operating vehicle 320. From the relevant driver profile, determination unit 214 may determine that because of road 300 is classified as a two-lane road where faster traffic travels in lane 302, the driver operating vehicle 320 has a statistical tendency (when traveling on road 300 or when traveling roads with the same characteristics (in this example, a two-lane road with two-traffic-speed zones of travel), to bias positioning of vehicle 320 to the right of the center region of a lane. For example, the driver of vehicle 320 may tend to be a more cautious driver that drives in the slower traffic lane, i.e., lane 304, and tends to move away from faster moving traffic.

Profiles may further comprise information regarding a person's stature (height, eye-line, etc.), or other physical traits that may impact lane biasing. Alternatively or in addition to the use of such profiles, monitor device 208 may assess such characteristics of a driver/passenger when physically in (e.g., seated) in the vehicle. That is, physical traits or characteristics, as well as certain physical preferences while in a vehicle can have an impact on lane biasing. For example, the viewpoint or perspective of a first passenger being of a certain height can differ from that of a second passenger being of a different height. That is, preferred lane biasing may be a function of a passenger's viewpoint. Consider scenarios where drivers bias the position of a vehicle based on some reference point, e.g., lining up the corner of the vehicle's hood with a right-most lane marker/line. It should be appreciated that a shorter driver using this reference point— based lane biasing will position his/her vehicle differently than a taller driver using the same point of reference (lining up the corner of his/her vehicle's hood with the right-most lane marker, even though they both use the same referencing technique. Thus, embodiments of the present disclosure may take into account such factors when determining how to lane bias a vehicle in accordance with a particular driver/passenger. The same holds true for physical positioning of the driver, for example, e.g., any variation in positioning or viewpoint in the various directions. That is, if a driver tends to crouch low in his/her seat or lean to one side when driving, that viewpoint can impact how he/she lane biases a vehicle.

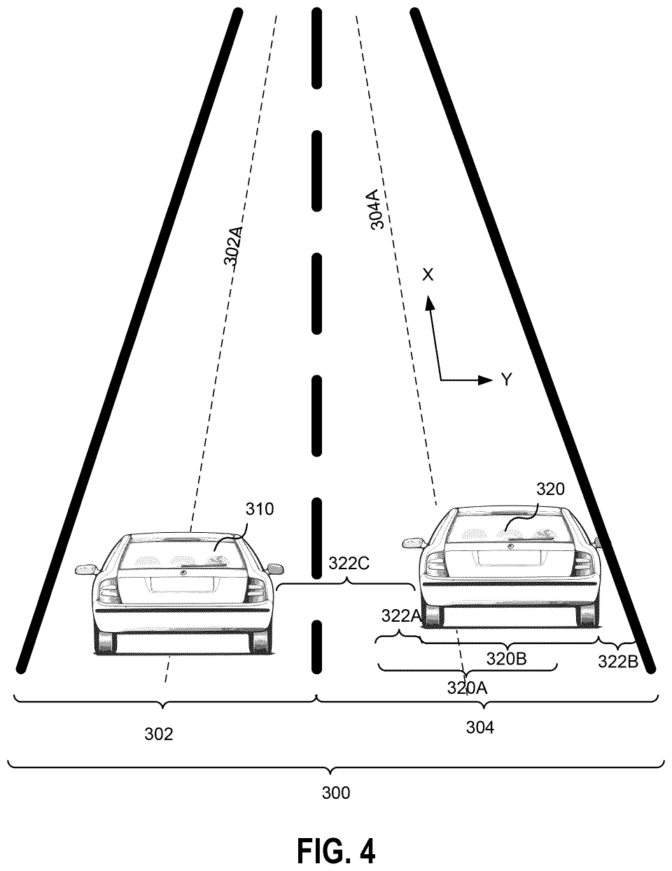

Accordingly, and as illustrated in FIG. 4, determination unit 214 may calculate how much steering torque and in what direction the steering torque should be applied based on a current position of vehicle 320. Referring back to FIG. 3, and assuming, for example, that when determination unit 214 makes its lane biasing position determination, vehicle 320 is in the center region 304A of lane 304 (although vehicle 320's current position can be anywhere in lane 304 (or may be traveling from another lane)). Reference position 320A reflects a current or original lane position of vehicle 320. Reference position 320B reflects a target or desired lane (bias) position of vehicle 320. Accordingly, determination unit may calculate a difference between the current/original lane position of vehicle 320 and vehicle 320's target/desired lane bias position, in this example, a distance offset 322A. Thus, determination unit 214 may, as described above, send instructions or signals to assist unit 250 instruction assist unit 250 to generate instructions or commands to apply an appropriate amount of steering torque in a direction to the right of center region 304A. Such instructions or signals may be transmitted to control unit 216, which translates the instructions or signals into commands executable by steering actuator 206A that directs vehicle 320 to autonomously move vehicle 320 to the right of center region 304A and by an amount of the distance offset 322A. Now, vehicle 320 is lane biased according to learned tendencies, preferences, or behaviors of the driver of vehicle 320.

As noted above, a variety of considerations may be taken into account by determination unit 214 when determining an appropriate lane bias position of a vehicle. For example, different vehicles or types of vehicles may have different dimensions, e.g., body width. Accordingly, the lane bias position may be impacted by the size of a vehicle, wherein a larger (in width) vehicle may need to be biased further to one side or another in a current lane of travel to effectuate a driver's desired amount of distance offset. Indeed, it should be noted that in addition to driver profiles, vehicle profiles may be generated/maintained, and used in the same (or similar) manner as driver profiles are used in accordance with various embodiments. Following the above example, the dimensions of a vehicle may make up a vehicle profile, so that determination unit 214, when calculating a distance offset, may further take in account, a vehicle's dimension. In this way, if a vehicle's dimensions necessitate increasing or decreasing a target distance offset to achieve a preferred lane biasing position in accordance with a driver profile, the target distance offset may be adapted accordingly. In some embodiments, other vehicle characteristics may be relevant to determining lane biasing. For example, a vehicle's wheels may not necessarily be optimally aligned or balanced. Accordingly, a vehicle may tend to drift or already exhibit some lane biasing tendencies (albeit unintentionally). Thus, lane biasing determinations can also account for certain vehicle characteristics, e.g., a target distance offset value may be appropriately lessened if, without doing so would cause the vehicle to ultimately overshoot the desired lane biasing position due to those certain vehicle characteristics.

It should be understand that achieving a target or desired lane biasing position, need not necessarily comprise calculating a distance offset from an original/current lane position. For example, a distance offset may be calculated relative to a center region/area of a lane. That is, driver/vehicle profile(s) may dictate that a desired lane biasing position is some given distance from one edge of a lane. Accordingly, a target distance offset, e.g., distance offset 322B, would be calculated by determination unit 214 relative to a lane edge or boundary. Accordingly, a vehicle's current distance from a lane edge or boundary may be determined (e.g., by external sensor 201, internal sensor 203, GPS reception unit 202, etc.). Determination unit 214 may then calculate the distance the vehicle must travel to the lane edge/boundary to achieve the desired lane biasing position. In other embodiments, a distance offset 322C may be calculated relative to a neighboring vehicle (or object, roadside infrastructure, etc.). In other words, different reference points or areas may be used or upon which distance offsets may be calculated. It should be further understood that lane biasing may more or less precise in accordance with different embodiments. For example, instead of calculating a “precise” or specific distance offset relative to a reference point/area, desired lane biasing position may be achieved so long as the vehicle at issue is within some threshold range of distance from the reference point/area, or simply, e.g., positioning a vehicle closer to one lane edge/boundary than the opposite lane edge/boundary.

Regarding multi-lane roads, especially expressways, embodiments of the present disclosure can learn how the driver positions a vehicle within a particular lane of a multi-lane road. For example, some drivers may bias a vehicle to the left on some lanes but then bias a vehicle to the right on other lanes of the same multi-lane road. Regarding static/dynamic objects, even if a static or dynamic object is not within the lane that the driver is utilizing, some drivers change their behavior regarding the positioning of the vehicle within the lane. For example, if a vehicle is located adjacent to an object in the right lane, the driver may bias the position of their vehicle slightly to the left. However, if a large vehicle is located adjacent to the driver in the left lane, and a smaller vehicle is adjacent to them in the right lane, the driver may position their vehicle slightly to the right. In other situations, a driver may hug the shoulder of the road in most situations, but will hug the left lane marker when the shoulder of the road includes an object, such as a rock, tree, pedestrian, bicyclist, cross walk, bus stop, cliff, etc.

It should be understood that the examples provided herein are not limiting, and can vary depending on the locale in which a vehicle is operating. For example, the shoulder of a road in the United States will be to the right of a lane, whereas in Australia, because vehicles are operated on the opposite side of the road, the shoulder of a road will be to the left of a lane.

The interaction between static/dynamic objects can also be considered as well. For example, when there is a combination of a barrier or median with other objects on the road, such as a large truck, the way the driver biases their vehicle within the lane can change. Again, different drivers will act differently based on situations embodiments of the present disclosure can learn such variations. The time of day and weather conditions can impact how a driver positions a vehicle within a particular lane, and as alluded to above, such conditions can be considered as factors in determining a target or desired distance offset from a center region of a lane of travel. For example, at nighttime or inclement weather, these changes may cause the driver to position their vehicle differently than during the day or in non-inclement weather.

Over time, determination unit 214 or (as noted above, a remote processor/server executing data analytics/machine learning) learns the preferred position of a vehicle for a driver by observing how the driver operates the vehicle in a non-autonomous mode and/or semi-autonomous mode (i.e., modes in which the driver is at least partially controlling the position of the vehicle within a lane). When operating in an autonomous/semi-autonomous mode, these driver preferences can be implemented to position the vehicle within a lane that is believed to best mimic the driver's behavior, leading to an overall improvement in comfort for the driver.

As noted above, in some embodiments, learning driver preferences/behavior can occur while a vehicle is operating in an autonomous mode. For example, and referring back to FIG. 3, autonomous control system 200 may be operating HEV 100 in a fully autonomous mode. Depending on conditions, such as road conditions, weather, etc., autonomous control system may position HEV 100 in a particular way within a lane of travel, for example. If the position of HEV 100 is undesirable to a passenger or driver of HEV 100, the driver or passenger may attempt to manually actuate steering wheel 209. In a fully autonomous mode, manual actuation of steering wheel 209 may result in determination unit 214 exiting the fully autonomous mode of operation, and giving control to the driver/passenger based on the sensed manual actuation of steering wheel 209 (e.g., by steering sensor 203A). In some embodiments, the attempted manual actuation of steering wheel 209 may be ignored, and fully autonomous control of HEV 100 may continue. Regardless of whether the fully autonomous mode of operation is maintained or exited (to manual or assisted mode), the attempted manual actuation of steering wheel 209 may still be monitored/observed and recorded as data for training determination unit 214.

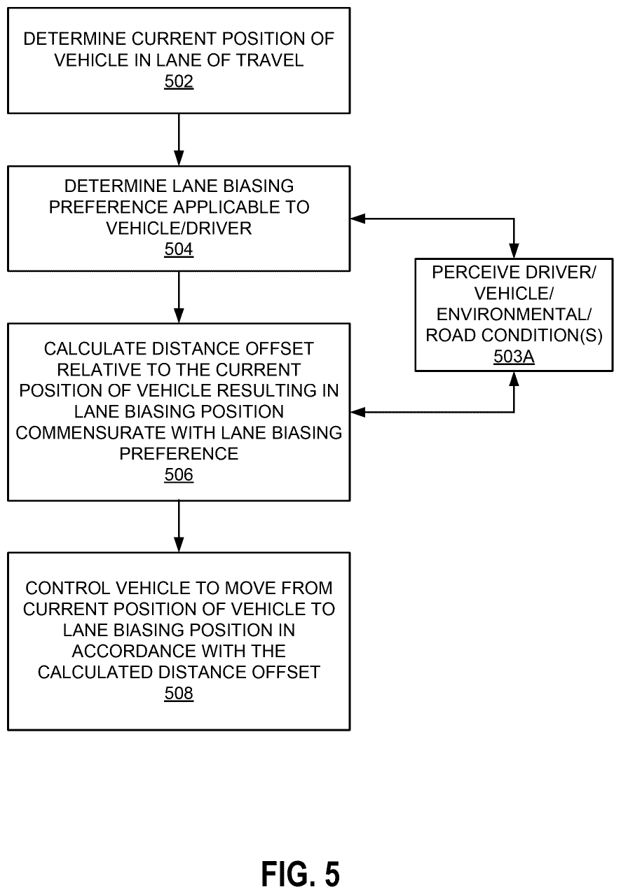

FIG. 5 is a flow chart illustrating example operations that may be performed to effectuate learned lane biasing. The operations illustrated in FIG. 5 and described herein may be performed by autonomous control system 200/one or more elements of autonomous control system 200, e.g., determination unit 214, assist unit 250, and control unit 216.

At operation 500, a current position of a vehicle in a lane of travel, e.g., current lane of travel, may be determined. As discussed above, autonomous control system 200 may determine a vehicle's current location or position. Such a determination can be made based on, e.g., camera imaging and analysis, location information, e.g., GPS-based location information, map-based location information, etc.

Because drivers/passengers may have a preference or exhibit historical behaviors that result in lane biasing, i.e., positioning/operating a vehicle off-center in a lane of travel, at operation 504, a lane biasing preference applicable to at least one of the vehicle and the driver of the vehicle is determined. In some embodiments, driver or vehicle profiles may be generated based on driver behaviors or preferences that have been learned, and vehicle characteristics.

In some embodiments, determining a lane biasing preference may further be dependent upon road conditions (amount of traffic, grade, type of road, etc.), vehicle conditions, such as current vehicle operating conditions (or characteristics), environmental conditions (current weather, existence of obstacles proximate to the vehicle, etc.), or driver conditions (aggressive driving mood, cautious driving mood, or other state(s) that may otherwise alter or affect a driver's learned lane biasing preferences). Accordingly, at operation 503A, such driver/vehicle/environmental/road conditions may be perceived. If any one or more such conditions impacts the determined lane biasing preference, autonomous control system, e.g., determination unit 214 may adjust or account for such conditions when calculating the aforementioned distance offset value relative to a reference point or area. For example, while a driver profile may indicate that a driver prefers to lane bias away from neighboring vehicles, road conditions may not allow for the full extent of the desired lane biasing position due to safety reasons. For example, when a driver is currently exhibiting aggressive driving behaviors, the driver profile may weight components or factors differently for determining an appropriate distance offset.

At operation 506, a distance offset relative to the current position of the vehicle resulting in a lane biasing position commensurate with the determined lane biasing preference. As described above, calculating the distance offset relative to the current position allows a target lane bias position to be achieved by determining in what direction a vehicle must be controlled to move and by how far, e.g., laterally in a lane of travel. It should be understood that lane of travel may be a current lane of travel or in some embodiments, may be another lane to be traveled to. For example, a vehicle may be purposeful changing lanes, and a desired lane biasing position may be applicable to the lane to which the vehicle is moving. Moreover, calculating a distance offset relative to a current position may further entail determining a reference point or area from which the vehicle should be distanced. It should be noted that perceived driver/vehicle/environmental/road conditions may be applied in the distance offset calculation in addition to determining lane biasing preferences or alternatively to doing so when determining lane biasing preferences.

At operation 508, the vehicle is controlled to move from its current position to the target or desired lane biasing position in accordance with the calculated distance offset. It should be understood that the distance offset may further comprise a direction in which the vehicle should travel to reach the target or desired lane biasing position.

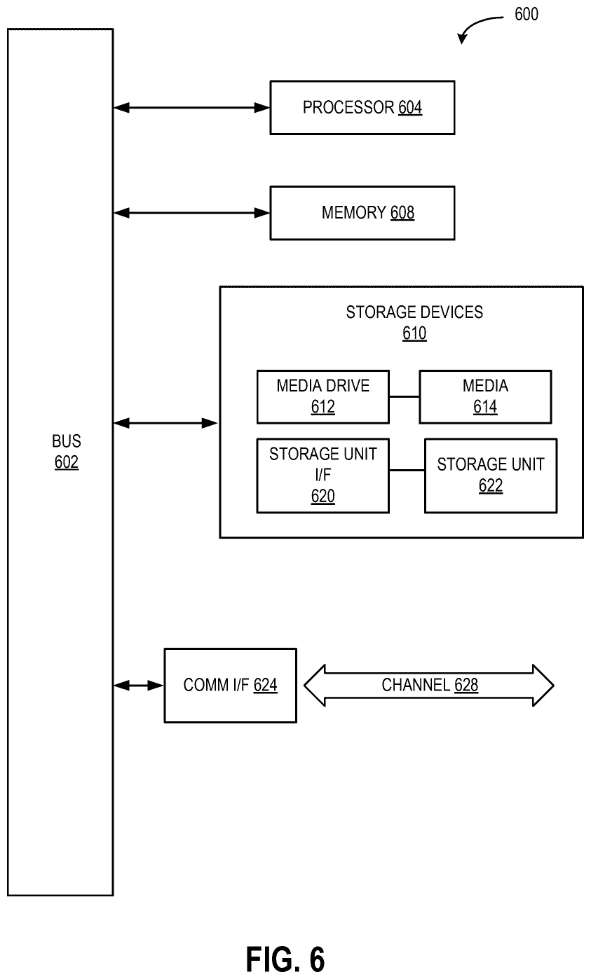

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor 604. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
determining a current position of a vehicle in a lane of travel;
determining a lane biasing preference applicable to at least one of the vehicle or the driver of the vehicle;
calculating a distance offset relative to the current position of the vehicle resulting in a lane biasing position commensurate with the lane biasing preference; and
autonomously or semi-autonomously controlling the vehicle to move from the current position of the vehicle in the lane of travel to the lane biasing position in accordance with the calculated distance offset.

2. The method of claim 1, wherein determining the lane biasing preference comprises obtaining the lane biasing preference from at least one of a vehicle profile, a passenger profile, or a driver profile.

3. The method of claim 2, wherein the vehicle profile comprises information reflecting at least one of physical vehicle characteristics or vehicle operating characteristics.

4. The method of claim 2, wherein the driver profile comprises information reflecting physical driver characteristics, and wherein the passenger profile comprises information reflecting physical passenger characteristics.

5. The method of claim 1, wherein determining the lane biasing preference comprises executing a machine learning model to predict the lane biasing preference.

6. The method of claim 1, wherein determining the lane biasing preference further comprises perceiving at least one of current driver conditions, current passenger conditions, current vehicle operating conditions, current environmental conditions, and current road conditions.

7. The method of claim 6, wherein determining the lane biasing preference further comprises adjusting the lane biasing preference in accordance with the at least one of the current driver conditions, current passenger conditions, current vehicle operating conditions, current environmental conditions, and current road conditions.

8. The method of claim 6, wherein calculating the distance offset further comprises adjusting the distance offset in accordance with the at least one of the current driver conditions, current passenger conditions, current vehicle operating conditions, current environmental conditions, and current road conditions, such that the adjusted distance offset still results in a lane biasing position commensurate with the lane biasing preference.

9. The method of claim 1, wherein the lane biasing preference reflects a preference based on historical lane biasing positions learned by the vehicle while being operated in one of a manual mode, a semi-autonomous mode, or a fully autonomous mode.

10. A system, comprising:
a processor; and
a memory unit including instructions that when executed cause the processor to:
learn, based on analyzing at least one of current and historical driver or passenger behaviors, a lane biasing preference;
calculate a distance offset relative to a current position of the vehicle resulting in a lane biasing position commensurate with the lane biasing preference; and
autonomously or semi-autonomously control the vehicle to move from the current position of the vehicle in a lane of travel to the lane biasing position in accordance with the calculated distance offset.

11. The system of claim 10, wherein the instructions, when executed, further cause the processor to store the at least one of the current and historical driver or passenger behaviors in the memory unit as a profile.

12. The system of claim 10, wherein the instructions, when executed, further cause the processor to determine a currently-applicable lane biasing preference by executing a machine learning model for predicting the lane biasing preference in accordance with the at least one of the learned current and historical driver or passenger behaviors.

13. The system of claim 12, wherein the instructions, when executed, further cause the processor to determine, via at least one monitoring device, physical driver characteristics or physical passenger characteristics.

14. The system of claim 13, wherein the instructions, when executed, further cause the processor to determine the currently-applicable lane biasing preference by executing the machine learning model for predicting the lane biasing preference in accordance with the at least one of the learned current and historical driver or passenger behaviors, and adjusted to account for at least one of the physical driver characteristics the physical passenger characteristics, or physical vehicle characteristics.

15. The system of claim 10, wherein the instructions that when executed cause the processor to calculate the distance offset further causes the processor through at least one monitoring device, to perceive at least one of current driver conditions, current passenger conditions, current vehicle operating conditions, current environmental conditions, and current road conditions.

16. The system of claim 15, wherein determining the lane biasing preference further comprises adjusting the lane biasing preference in accordance with the at least one of the current driver conditions, current passenger conditions, current vehicle operating conditions, current environmental conditions, and current road conditions.

17. The method of claim 16, wherein the instructions that when executed cause the processor to calculate the distance offset further causes the processor to adjust the distance offset in accordance with the at least one of the current driver conditions, current passenger conditions, current vehicle operating conditions, current environmental conditions, and current road conditions, such that the adjusted distance offset still results in a lane biasing position commensurate with the lane biasing preference.

18. The system of claim 10, wherein the instructions that when executed cause the processor to learn the lane biasing preference, are executed while the vehicle is being operated in one of a manual mode, a semi-autonomous mode, or a fully autonomous mode.
